(19) United States
(12) Patent Application Publication
(10) Pub. No.: US 2015/0074718 A1
(43) Pub. Date: Mar. 12, 2015

(54) ELECTRONIC PROGRAMMING GUIDE WITH REAL-TIME AUDIO VIDEO CONTENT INFORMATION UPDATES

(71) Applicant: Sony Corporation, Tokyo (JP)

(72) Inventor: Jeffrey Moguillansky, San Diego, CA (US)

(73) Assignee: Sony Corporation, Tokyo (JP)

(21) Appl. No.: 14/023,843

(22) Filed: Sep. 11, 2013

(51) Int. Cl. H04N 21/482; H04N 21/4722

(52) U.S. Cl. CPC H04N 21/482; H04N 21/4722
USPC 725/40

(57) ABSTRACT

An audio video device (AVD) includes a processor configured for controlling a display, as well as a at least one computer readable storage medium that is not a carrier wave and that is accessible to the processor. The computer readable storage medium bears instructions which when executed by the processor cause the processor to present, on the display, at least an user interface (UI) of available audio video (AV) content (programming). The UI includes information for at least one available AV content including a first AV content. Further, the information for the first AV content includes the current number of other AVDs presenting the first AV content, the current rating of the first AV content, the current number of likes or dislikes of the first AV content, the current number of comments regarding the first AV content, and/or an indication of whether the first AV content is currently trending.

### FIELD OF THE INVENTION

The present application relates generally to presenting audio video (AV) content information on user interfaces.

### BACKGROUND

User interfaces (UIs) such as electronic programming guides (EPGs) that are presentable on display devices generally contain information for various audio video (AV) contents that are available for presentation on the display device. This information may include things such as e.g. the time that the AV content is airing on a particular TV channel, the actors or participants of the AV content, and the title of the AV content. Present principles recognize that still other information may be presented on an EPG.

### SUMMARY OF THE INVENTION

In a first aspect, an audio video device (AVD) includes a processor configured for controlling a display, as well as a at least one computer readable storage medium that is not a carrier wave and that is accessible to the processor. The computer readable storage medium bears instructions which when executed by the processor cause the processor to present, on the display, at least an user interface (UI) of available audio video (AV) content (programming). The UI includes information for at least one available AV content including a first AV content. Further, the information for the first AV content includes the current number of other AVDs presenting the first AV content, the current rating of the first AV content, the current number of likes or dislikes of the first AV content, the current number of comments regarding the first AV content, and/or an indication of whether the first AV content is currently trending.

In some embodiments, the first AV content may be a television broadcast and the UI may be an electronic programming guide (EPG). Also in some embodiments, the information included on the UI may be received from an Internet server at least in part using a hypertext transfer protocol (HTTP) application programming interface (API).

Furthermore, if desired, one or more of the following portions of information may be updated on the UI substantially in real time as the UI is being presented on the display: the current number of other AVDs presenting the first AV content, the current rating of the first AV content, the current number of likes or dislikes of the first AV content, the current number of comments concerning the first AV content, and the indication of whether the first AV content is currently trending. Further describing the likes and dislikes that may be updated substantially in real time, they may be associated with input to a social networking service to which the processor is configurable to have access. In addition to or in lieu of the foregoing, the likes and dislikes may be an aggregation of likes and dislikes of the first AV content based on input to plural social networking services, where the number of likes and dislikes input using the social networking services is accessible to the processor.

In another aspect, a method includes presenting, on a display, a user interface (UI) including information for each of plural audio video (AV) contents and updating the information on the UI as the UI is presented. The updating is done substantially in real time as at least one information update for at least one portion of the information for at least one AV content is received. Further, information presented for a first AV content includes a view count of the number of current presentations of the AV content on separate consumer electronics (CE) devices, where the view count is updated on the UI substantially in real time as an information update for the view count is received.

In still another aspect, a computer readable storage medium that is not a carrier wave bears instructions which when executed by a processor of a consumer electronics (CE) device configure the processor to execute logic including presenting, on a display device controllable by the processor, at least an user interface (UI) of available audio video (AV) content. The UI presents information for at least a first AV content. The information for the first AV content includes the current number of individual consumer electronics (CE) device instances that have been set at respective CE devices to record the first AV content on the respective CE devices.

The details of the present invention, both as to its structure and operation, can best be understood in reference to the accompanying drawings, in which like reference numerals refer to like parts, and in which:

### BRIEF DESCRIPTION OF THE DRAWINGS

FIG. 1 is a block diagram of an exemplary system including a CE device in accordance with present principles;

FIG. 2 is an exemplary flowchart of logic to be executed by a CE device to present a current information user interface in accordance with present principles;

FIG. 3 is an exemplary flowchart of logic to be executed by a server for providing current information for one or more AV contents in accordance with present principles;

FIGS. 4-10 are exemplary current information user interfaces in accordance with present principles; and

FIG. 11 is an exemplary current information settings UI in accordance with present principles.

### DETAILED DESCRIPTION OF THE PREFERRED EMBODIMENT

Disclosed are methods, apparatus, and systems for consumer electronics (CE) device based user information. A system herein may include server and client components, connected over a network such that data may be exchanged between the client and server components. The client components may include one or more computing devices. These may include televisions (e.g. computerized TVs, Internet-enabled TVs, and/or high definition (HD) TVs), personal computers, laptops, tablet computers, and other mobile devices including computerized “smart” phones. These client devices may operate with a variety of operating environments. For example, some of the client computers may be running Microsoft Windows® operating system. Other client devices may be running one or more derivatives of the Unix operating system, or operating systems produced by Apple® Computer, such as the IOS® operating system, or the Android® operating system, produced by Google®. While examples of client device configurations are provided, these are only examples and are not meant to be limiting. These operating environments may also include one or more browsing programs, such as Microsoft Internet Explorer®, Firefox, Google Chrome®, or one of the other many browser programs. The browsing programs on the client devices may be used to access web applications hosted by the server components discussed below.

Server components may include one or more computer servers executing instructions that configure the servers to receive and transmit data over the network. For example, in some implementations, the client and server components may be connected over the Internet. In other implementations, the client and server components may be connected over a local intranet, such as an intranet within a school or a school district. In other implementations a virtual private network may be implemented between the client components and the server components. This virtual private network may then also be implemented over the Internet or an intranet.

The data produced by the servers may be received by the client devices discussed above. The client devices may also generate network data that is received by the servers. The server components may also include load balancers, firewalls, caches, and proxies, and other network infrastructure known in the art for implementing a reliable and secure web site infrastructure. One or more server components may form an apparatus that implement methods of providing a secure community to one or more members. The methods may be implemented by software instructions executing on processors included in the server components. These methods may utilize one or more of the user interface examples provided below.

The technology is operational with numerous other general purpose or special purpose computing system environments or configurations. Examples of well-known computing systems, environments, and/or configurations that may be suitable for use with the invention include, but are not limited to, TVs, personal computers, server computers, hand-held or laptop devices, multiprocessor systems, processor-based systems, programmable consumer electronics, network PCs, minicomputers, mainframe computers, distributed computing environments that include any of the above systems or devices, and the like.

As used herein, instructions refer to computer-implemented steps for processing information in the system. Instructions can be implemented in software, firmware or hardware and include any type of programmed step undertaken by components of the system.

A processor may be any conventional general purpose single- or multi-chip processor such as the AMD® Athlon® II or Phenom® II processor, Intel® i3®/i5®/i7® processors, Intel Xeon® processor, or any implementation of an ARM® processor. In addition, the processor may be any conventional special purpose processor, including OMAP processors, Qualcomm® processors such as Snapdragon®, or a digital signal processor or a graphics processor. The processor typically has conventional address lines, conventional data lines, and one or more conventional control lines.

The system is comprised of various modules as discussed in detail. As can be appreciated, each of the modules comprises various sub-routines, procedures, definitional statements and macros. The description of each of the software/logic/modules is used for convenience to describe the functionality of the preferred system. Thus, the processes that are undergone by each of the software/logic/modules may be arbitrarily redistributed to one of the other software/logic/modules, combined together in a single software process/logic flow/module, or made available in, for example, a shareable dynamic link library.

The system may be written in any conventional programming language such as C#, C, C++, BASIC, Pascal, or Java, and run under a conventional operating system. C#, C, C++, BASIC, Pascal, Java, and FORTRAN are industry standard programming languages for which many commercial compilers can be used to create executable code. The system may also be written using interpreted languages such as Pert Python or Ruby. These are examples only and not intended to be limiting.

Those of skill will further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

In one or more example embodiments, the functions and methods described may be implemented in hardware, software, or firmware executed on a processor, or any combination thereof. If implemented in software, the functions may be stored on or transmitted over as one or more instructions or code on a, computer-readable storage medium. Computer-readable media include both computer storage media and communication media including any medium that facilitates transfer of a computer program from one place to another. However, a computer readable storage medium is not a carrier wave, and may be any available media that can be accessed by a computer. By way of example, and not limitation, such computer-readable storage media can comprise RAM, ROM, EEPROM, CD-ROM or other optical disk storage, magnetic disk storage or other magnetic storage devices, or any other medium that can be used to store desired program code in the form of instructions or data structures and that can be accessed by a computer. Also, any connection may be properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as may be used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

The foregoing description details certain embodiments of the systems, devices, and methods disclosed herein. It will be appreciated, however, that no matter how detailed the foregoing appears in text, the systems, devices, and methods can be practiced in many ways. As is also stated herein, it should be noted that the use of particular terminology when describing certain features or aspects of the invention should not be taken to imply that the terminology is being re-defined herein to be restricted to including any specific characteristics of the features or aspects of the technology with which that terminology is associated.

It will be appreciated by those skilled in the art that various modifications and changes may be made without departing from the scope of the described technology. Such modifications and changes are intended to fall within the scope of the embodiments. It will also be appreciated by those of skill in the art that parts included in one embodiment are interchangeable with other embodiments; one or more parts from a depicted embodiment can be included with other depicted embodiments in any combination. For example, any of the various components described herein and/or depicted in the Figures may be combined, interchanged or excluded from other embodiments.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” While various aspects and embodiments have been disclosed herein, other aspects and embodiments may be apparent. The various aspects and embodiments disclosed herein are for purposes of illustration and are not intended to be limiting.

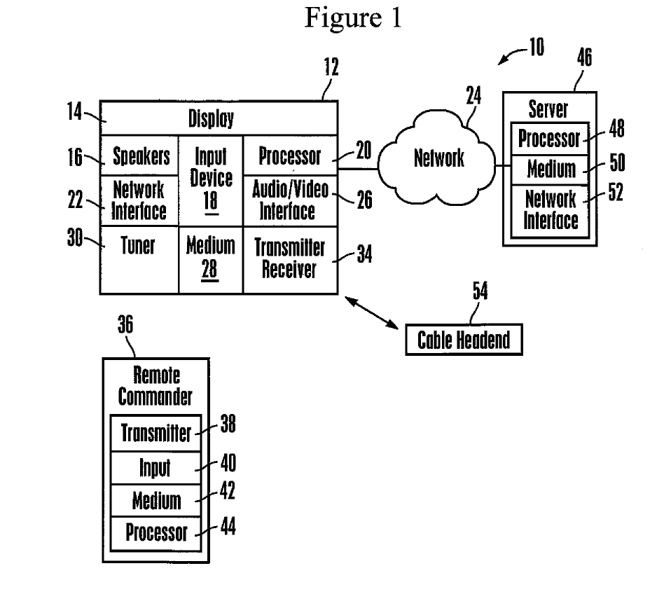

Referring now to FIG. 1, an exemplary system 10 includes at least one consumer electronics (CE) device 12 that in exemplary embodiments is a television (TV) such as e.g. a high definition TV and/or Internet-enabled computerized TV (e.g. a “smart” TV). However, present principles recognize that the CE device 12 may also be e.g. a wireless and/or mobile telephone, a set top box, digital video recorder, computerized (e.g. “smart”) phone (e.g., an Internet-enabled and touch-enabled mobile telephone), a laptop computer, a desktop computer, a tablet computer, a PDA, a video game console, a video player, a personal video recorder, a computerized (e.g. “smart”) watch, a music player, etc. Regardless, it is to be understood that the CE device 12 is configured to undertake present principles (e.g. to present an EPG in accordance with present principles).

Describing the CE device 12 with more specificity, it includes a touch-enabled display 14, one or more speakers 16 for outputting audio, and at least one additional input device 18 such as, e.g., an audio receiver/microphone, keypad, touchpad, etc. for providing input and/or commands (e.g. audible commands) to a processor 20 for controlling the CE device 12 such as e.g. controlling an electronic programming guide (EPG) and/or selecting elements thereon in accordance with present principles. The CE device 12 also includes a network interface 22 for communication over at least one network 24 such as the Internet, an WAN, a LAN, etc. under control of the processor 20, it being understood that the processor 20 controls the CE device 12 including presentation of an EPG as disclosed herein. Furthermore, the network interface 22 may be, e.g., a wired or wireless modem or router, or other appropriate interface such as, e.g., a wireless telephony transceiver.

In addition to the foregoing, the CE device 12 may include an audio video interface 26 such as, e.g., a USB or HDMI port for receiving input (e.g. AV content) from a component device such as e.g. a set top box or Blue Ray disc player for presentation of the content on the CE device 12, as well as a tangible computer readable storage medium 28 such as disk-based or solid state storage. The medium 28 is understood to store the software code and/or logic discussed herein for execution by the processor 20 in accordance with present principles. Further still, the CE device 12 may also include a TV tuner 30 and a GPS receiver (not shown for clarity) that is configured to receive geographic position information from at least one satellite and provide the information to the processor 20 to undertake present principles such as e.g. providing current and/or real-time information in accordance with present principles for a particular geographic area (e.g. the area in which the CE device 12 is disposed), though it is to be understood that another suitable position receiver other than a GPS receiver may be used in accordance with present principles.

Moreover, it is to be understood that the CE device 12 also includes a transmitter/receiver 34 for communicating with a remote commander (RC) 36 associated with the CE device 12 and configured to provide input (e.g., commands) to the CE device 12 (e.g. to the processor 20) to thus control the CE device 12. Accordingly, the RC 36 also has a transmitter/receiver 38 for communicating with the CE device 12 through the transmitter/receiver 34. The RC 36 also includes an input device 40 such as a keypad or touch screen display, as well as a processor 42 for controlling the RC 36 and a tangible computer readable storage medium 44 such as disk-based or solid state storage. Though not shown, in some embodiments the RC 36 may also include a touch-enabled display screen and a microphone that may be used for providing input/commands to the CE device 12 in accordance with present principles.

Still in reference to FIG. 1, reference is now made to a server 46 of the system 10. The server 46 includes at least one processor 48, at least one tangible computer readable storage medium 50 such as disk-based or solid state storage, and at least one network interface 52 that, under control of the processor 48, allows for communication with the CE device 12 (and even a cable head end 54 to be described shortly) over the network 24 and indeed the server 46 may facilitate communication between the CE device 12, server 46, and cable head end 54. Note that the network interface 52 may be, e.g., a wired or wireless modem or router, or other appropriate interface such as, e.g., a wireless telephony transceiver. Accordingly, in some embodiments the server 46 may be an Internet server, may facilitate the transmission of and indeed provide current information (e.g. in conjunction with data received from the cable head end 54) for presentation on an EPG in accordance with present principles, and may include and perform “cloud” functions such that the CE device 12 may access a “cloud” environment via the server 46 in exemplary embodiments if desired. Additionally, note that the processors 20, 42, and 48 are configured to execute logic and/or software code for their respective devices as disclosed herein.

Describing the head end 54 mentioned above, it is to be understood that although the head end 54 is labeled as a cable head end in particular in FIG. 1, it may be a satellite head end as well. The head end 54 is understood to be in communication with the CE device 12 and/or server 46 over, e.g., a closed network (through a wired or wireless connection), and furthermore may itself include a network interface (not shown) such that the head end 54 may communicate with the CE device 12 and/or server 46 over a wide-area and/or open network such as the network 24. Further still, it is to be understood that the head end 54 may be wired or wirelessly connected to a non-internet server, and/or may optionally be integrated with a non-Internet server. In any case, it is to be understood that the head end 54 may facilitate the transmission of EPG information to the CE device 12 in accordance with present principles.

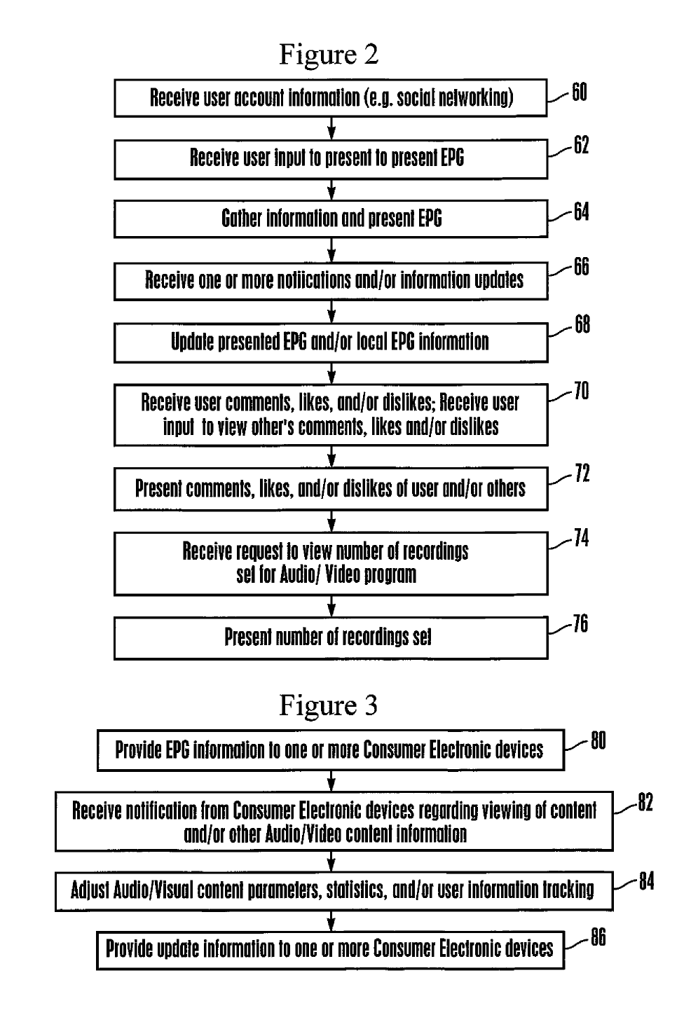

Turning now to FIG. 2, an exemplary flowchart of logic to be executed by a CE device such as the CE device 12 to present current and/or Teal-time audio video (AV) content information on an EPG for respective contents is shown. Beginning at block 60, the logic receives user account information (e.g. login information) for one or more social networking accounts so that an EPG to be presented on the CE device 12 can be associated with, linked to, and/or present information from at least one social networking service such as e.g. Facebook, Twitter, Instagram, LinkedIn, Pinterest, Google+, etc. in accordance with present principles. Also at block 60, the logic may sign in to one or more of the social networking accounts for which account information has been provided to thereafter receive, extract, and/or otherwise determine data to be included in EPG information in accordance with present principles.

The logic then proceeds to block 62, where the logic receives user input to present an EPG on a display of the CE device (e.g., when the CE device and/or associated set top box is powered on). The logic then moves to block 64 where the logic gathers (e.g. from a server and/or cable head end) the current, most recent, and/or real-time information of one or more types for one or more AV contents to be included on an EPG in accordance with present principles (e.g. real-time information for each of plural AV contents to be included on a panel/entry on the EPG for each of the plural AV contents). Also at block 64, the logic presents the EPG. Thereafter, the logic proceeds to block 66 where the logic receives or otherwise gathers and/or determines one or more notifications and/or information updates concerning at least some of the real-time information presented on the EPG, and then at block 68 the logic updates the EPG presented on the CE device and/or also updates EPG information and/or data stored locally on a storage medium of the CE device for later presentation on an EPG.

Continuing the description of FIG. 2, after block 68 the logic proceeds to block 70, where the logic receives one or more user commands, comments, likes, dislikes, etc. (e.g. and still other user-input information as disclosed herein) that pertain to e.g. a particular piece of AV content presented on the CE device and/or AV content information presented the EPG, and may even provide this information and/or data to a cable head end and/or server for incorporation into statistics and/or real-time information maintained and provided by the cable head end and/or server to CE devices in accordance with present principles. For instance, an RC associated with the CE device may have a dedicated Facebook “like” button that, when selected, provides input to the CE device processor indicating that the viewer “likes” the currently-presented AV content which the processor may then provide to a Facebook application for publishing on the user's Facebook profile and/or newsfeed. Regardless, also at block 70 the logic may receive user input to view other people's comments, likes, and/or dislikes (e.g. on an EPG) in accordance with present principles.

Next, the logic proceeds to block 72 where the logic presents any requested and/or all current (e.g. real-time, dynamically updated) information for the requested information type such as social networking comments on a particular AV content, likes and dislikes for a particular AV content, etc. The logic then moves to block 74 where the logic receives a request to present information related to the current number of recordings and/or recording commands that have been set at other CE devices to record an AV content (e.g. an AV content indicated on the presented EPG that is upcoming and/or otherwise has yet to be made available to the CE device from a cable head end or server). The logic then concludes at block 76 where the logic presents the requested recording information.

Continuing the detailed description in reference to FIG. 3, exemplary logic is shown that may be executed by e.g. a server and/or cable head end in accordance with present principles. Beginning at block 80 the logic provides (e.g. requested) EPG data and/or information to one or more CE devices that includes e.g. current information on one or more AV contents to be presented on an EPG in accordance with present principles. The logic then moves to block 82 where the logic receives data and/or notifications from one or more CE devices regarding the viewing of one or more AV contents on each of the respective CE devices for which data and/or notifications are received. The data and/or notifications are understood to pertain to e.g. whether a viewer has changed from viewing one AV content being streamed and/or provided to a CE device via the server/head end to another AV content, and whether the user has “liked” the content, set the CE device and/or set top box/DVR associated therewith to record an AV content at least in part by manipulating the provided EPG, etc. The data and/or notifications are understood to pertain to and/or include still other data and/or information as disclosed herein such as that related to e.g. ratings, comments, trends, etc.

In any case, after block 82 the logic proceeds to block 84 where the logic adjusts one or more AV content parameters and/or current data metrics for the AV content for which the one or more notifications have been received, as well as any other information related to the tracking of user behavior and/or EPG or CE device manipulation, and may even store the (updated) parameters and/or metrics on a local storage medium of the server and/or head end so that the information is readily accessible e.g. whenever a CE device in communication with the server/head end makes a request for such information to the server. The logic of FIG. 3 then concludes at block 86 where the logic provides updated current information to one or more CE devices (e.g. including or other than the one or more CE devices that provided the notifications received at block 82) to reflect the adjustments made to the information at block 84 and thus to provide substantially real-time information updates in accordance with present principles.

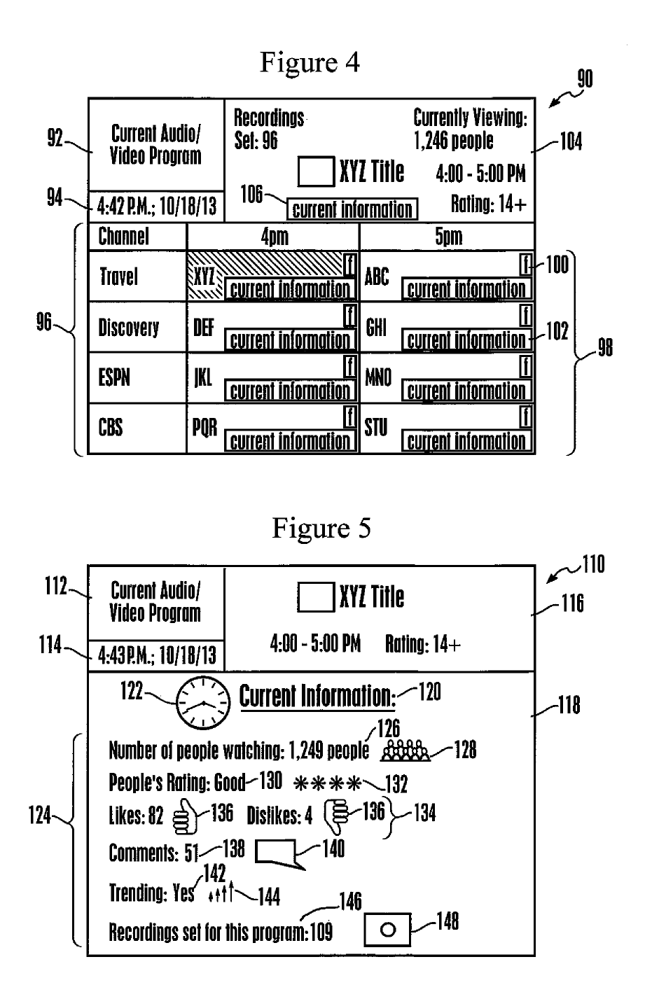

Continuing the detailed description in reference to FIGS. 4-10, these figures show exemplary current information UN that are presentable on a CE device in accordance with present principles. Beginning first with FIG. 4, a current information UI 90 is shown, it being understood that the UI 90 may be presented automatically without further user input responsive to e.g. selection of a guide button on a RC. The UI 90 includes a current video portion 92 on an upper left corner thereof that presents video from a currently selected AV content (e.g., the AV content being presented prior to evoking a function on the CE device causing the UI 90 to be presented). Also shown is current temporal information area 94 that may include current temporal information such as the time of day and date.

In addition to the foregoing, the UI 90 includes a channel and AV content portion 96 that presents AV content information in e.g. a grid and/or panel layout form. As may be appreciated from FIG. 4, the portion 96 includes a listing of channels on a left portion thereof, and also at least one panel 98 indicating an AV content that is or will be provided on that channel at a particular time.

Accordingly, as an example and as may be appreciated from FIG. 4, AV content XYZ is being provided on the Travel channel from four to five p.m. on Oct. 8, 2013. As may also be appreciated from FIG. 4, at least one panel 98 (and as shown in FIG. 4, all panels 98) may include a social networking selector element 100 that may include an icon associated with a social networking service that is selectable by a user to initiate and/or execute a social networking function using the social networking service and pertaining to the AV content for the respective panel. For instance, manipulating a cursor using an RC to select the selector element 100 may cause an overlay comment box to automatically be presented without further user input to which a user may enter text to comment on the particular AV content associated with the panel 98 from which the selector element 100 was selected. The comment may then be shared by selecting a submit selector on the overlay comment box. The comment may be shared by e.g. being published via the social networking service itself and/or being subsequently presented on EPGs presented on CE devices in accordance with present principle such that e.g. a friend of the user providing the comment on one CE device may view the comment on a current information EPG presented on the friend's CE device.

In addition to the social networking selector element 100, at least one of the panels 98 may also include a current information selector element 102 that is selectable to cause current information to be presented that is associated with the respective AV content for the panel on which the selected selector element 102 is presented (e.g., the current information may be presented on e.g. an overlay screen and/or another UI, such as the one shown in FIG. 5 to be described shortly).

Still in reference to FIG. 4, the UI 90 also includes a detailed current information portion 104 for a particular AV content associated with a panel 98 that is e.g. highlighted or selected on the UI 90, and thus may dynamically and automatically change responsive to another of the panels 98 being navigated to or otherwise selected on the UI 90 e.g. using a RC. In the present exemplary instance, it may be appreciated that at least a portion of the panel 98 for AV content XYZ is shaded to denote that it is currently selected (e.g. using a cursor moved to the XYZ AV content panel 98), and thus detailed current information for the selected XYZ AV content panel 98 is presented in the portion 104. The detailed current information presented on the portion 104 may include information such as the AV content's title, an icon or thumbnail image associated with the AV content, an indication of the current number of recording instances set at other CE devices to record AV content XYZ, an indication of the current number of other CE devices currently presenting AV content XYZ, the time during which AV content XYZ will be provided on the Travel channel, the current rating of AV content XYZ as determined based on e.g. real-time updated user-input ratings, and also if desired a current information selector element 106 that is selectable to cause still further information associated with AV content XYZ to be presented (e.g., such as that shown on the UI of FIG. 5).

Now in reference to the afore-mentioned FIG. 5, a detailed current information UI 110 is shown that may be presented automatically without further user input responsive to e.g. selection of a current information selector element for AV content XYZ from the UI 90 (e.g. either or both of the current information selector element for the XYZ panel 98 or the selector element 106). A current video portion 112 is shown on the UI 110, as well as a current temporal information area 114 that may be e.g. similar to the portion 92 and area 94 described above, respectively. Next to the portion 112 and area 114 on an upper portion of the UI 110 is an information portion 116 for a particular AV content associated with a UI panel that has been selected (or specific selector element on a panel) in accordance with present principles. The portion 116 may include information for the selected AV content such as e.g. the AV content title, an icon or thumbnail image associated with the AV content, the time when the AV content will be provided, and e.g. a AV content provider-provided rating for the AV content.

In addition to the foregoing, the UI 110 includes a detailed information portion 118 that includes different types of current information associated with the AV content that is updated and/or updateable in real time or substantially in real time in accordance with present principles. The portion 118 may include a title 120 indicating that the portion 118 pertains to detailed current information regarding the subject AV content, as well as an icon 122 such as e.g. a clock reflecting the current time of day during which the UI 110 is presented to denote that the information presented on the portion 118 is current or substantially current based on the most-recent available information. Further still, at least one informative indication 124 is provided on the portion 118, with each one indicating what the respective parameter or metric pertains to and also optionally including an icon or image associated therewith that symbolizes the respective particular information.

Thus, for example, an indication 126 of the current number (e.g. view count) of CE devices presenting AV content XYZ includes a number (in this case one thousand, two hundred, and forty nine people), along with an image/icon 128 of a crowd to indicate that a large number of people are viewing AV content XYZ on their CE devices. Still other current information for the AV content may be presented on the portion 118, including e.g. an indication 130 of the current rating of the AV content based on e.g. end-user ratings rather than e.g. Federal Communication Commission guidelines and/or AV content provider-provided ratings, along with an image/icon 132 of a star-based rating, an indication 134 of the current number of likes and/or dislikes of the AV content (e.g. including specific indications of likes or dislikes by social networking friends of the user associated with the CE device) along with one or more images/icons 136 for likes and dislikes such as images of a hand with a thumb up or down, an indication 138 of the current number of comments regarding the AV content along with an image/icon 140 symbolizing comments such as the image of a caption box, an indication 142 of whether the AV content is currently trending along with an image/icon 144 of up arrows getting progressively longer left to right to indicate the subject AV content is trending and continues to trend even more (e.g., conversely if the arrows point down the image/icon 144 may indicate the subject AV content is trending less and less), and an indication 146 of the current number of instances on different (and/or separate) CE devices where the respective CE device and/or set top box/DVR associated therewith has been set to record the subject AV content along with an image/icon 148 in the present instance denoting a recording feature by way of a record button.

Still in reference to FIG. 5, it is to be understood that although at the time the UI 110 is initially presented responsive to a request for it (e.g. selection of a current information selector element), the indications and/or information provided thereon may change over time as the UI 110 continues to be presented (e.g. without being removed from the display screen on which it is presented). Thus, it is to be understood that the information and/or indications presented on the UI 110 may change and update dynamically in real time as the CE device presenting the UI 110 receives information updates from e.g. a server or head end in accordance with present principles. For instance, the indication 126 of the number of people watching AV content XYZ as presented on the UI 110 may increase or decrease over time as the UI 110 is presented. Any and/or all other indications and information may similarly dynamically and without user input change as information updates pertaining to that particular type of information are received by CE device and/or made available where the CE device may access it (e.g. on a website or remote storage location such as a server and/or “cloud”). Indeed, any and/or all of the current information for AV content described herein that is presentable on any of the UIs of FIGS. 4-10 may be similarly updated and dynamically changed on the respective UIs as described herein.

Accordingly, it is to be understood that the CE device presenting current information EPGs in accordance with present principles may receive information updates as described herein and/or determine the information by accessing it when stored not on the CE device (e.g. on a server computer readable storage medium, on a website, via a social networking service to which the CE device has access, etc.). Further still, in some embodiments the real-time information may be communicated from a server at least in part using a hypertext transfer protocol (HTTP) application programming interface (API). E.g., a HTTP representational state transfer (REST) protocol may be used and thus, e.g., a javascript command may be provided to the server, and the server may in turn respond with a javascript object notation (JSON).

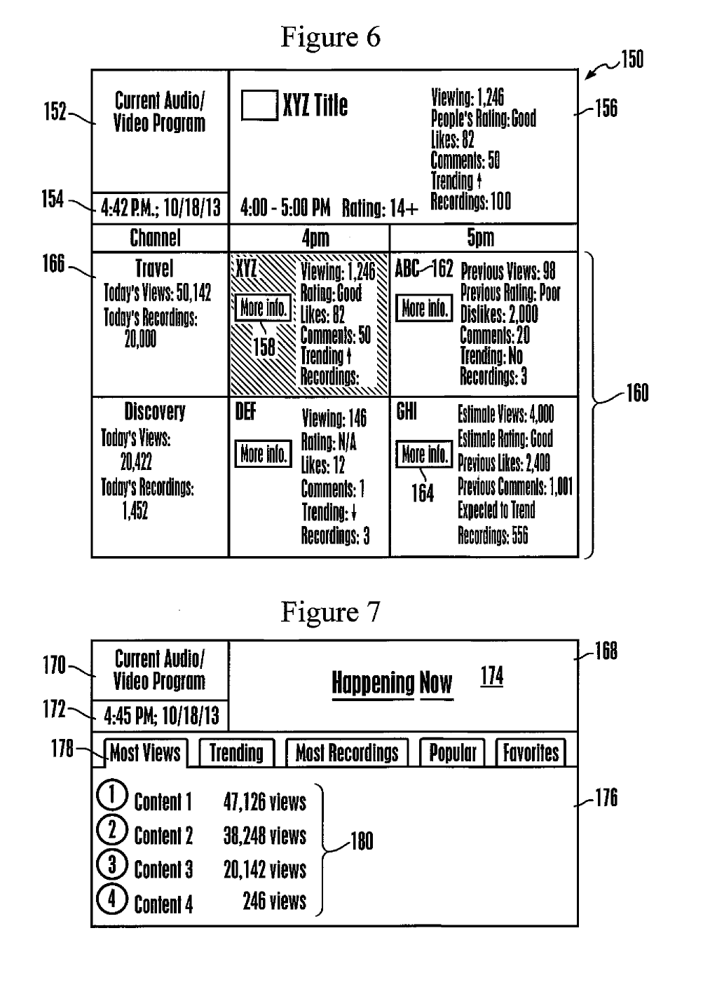

Turning now to FIG. 6, a detailed current information UI 150 (e.g. an EPG) is shown. Note that e.g. the UI 150 may be presented e.g. automatically without further user input responsive to e.g. selection of a guide button on a RC in lieu of the UI 90 of FIG. 4 based on e.g. EPG settings set by a user as will be described further in reference to FIG. 11. In any case, the UI 150 may include a current video portion 152 as well as a current temporal information area 154 that may be e.g. similar to the portion 92 and area 94 described above, respectively. Also shown is a detailed current information portion 156 for a particular AV content associated with a panel 158 that is e.g. highlighted or selected on the EPG (denoted by the background shading for the panel 158). If desired and as shown, the upper portion 156 may include at least one indication of current information for the subject AV content, and in the present instance it includes indications of the current view count for the AV content (and/or e.g. daily view count for the channel itself), the current rating, the current number of likes, the current number of comments, whether the AV content is trending, and the current number of instances the AV content is being recorded.

In addition to the foregoing, the detailed current information UI 150 may also include a level of information for various AV content information panels 160 presented thereon that is e.g. relatively more detailed than the UI 90 described above. Each of the panels 160 may include one or more of the following indications, as well as any other indication described herein: the current view count for the AV content of the respective panel 160, the current rating, the current number of likes, the current number of comments, whether the AV content associated with the respective panel 160 is trending, and the current number of instances the AV content associated with the respective panel 160 is being recorded. Even further, in addition to an AV content title 162 for the AV content associated with the respective panel 160, at least one of the panels 160 may include a more information selector element 164 that is selectable to cause still more current information regarding the AV content associated with the respective selector element 164 to be presented, such as e.g. presenting the UI 110 of FIG. 5.

Still in reference to FIG. 6, also note that in addition to the current information indications described above, still other current information may be conveyed using the UI 150, including current, real-time dynamically updated information for the various channels themselves that are represented on the UI 150. Thus, for instance, channel area 166 for the Travel channel includes indications of the cumulative view count of CE devices that have viewed any AV content provided on the subject channel at any point during the day, and a cumulative recording count of the total recordings of one or more AV contents provided on the subject channel. Still other current information indications may be provided for the channels as well, including e.g. a user-determined rating, the number of channel likes or dislikes, the number of comments about the channel, whether the channel is trending or not, etc.

Additionally, before moving on to FIG. 7, it is to be understood that still other information may be presented on panels 160 for which e.g. current information may not be available. For instance, if a panel pertains to a content yet to be provided by a channel (e.g. such as the respective panels on the UI 150 for AV content ABC and AV content GHI that are to be aired in the future at five p.m. when the current time as indicated is only four forty two p.m.), then a current view count cannot be provided since the content is not yet being provided on the respective channel. However, other information and/or estimates may be provided such as e.g. the estimated number of views the AV content will receive, the estimated rating, whether the AV content is expected to trend, the number of planned recordings according to e.g. a server that has received recording notifications in accordance with present principles, etc.

Furthermore, in some embodiments the information may pertain to past presentations of the AV content either on the particular channel that is about to present the content as shown on the UI 150 or any other channel. The indications of such information may include e.g. the total number of views the AV content has ever received or received for the most-recent previous presentation, the all-time rating for the AV content or the most-recent rating for the most recent presentation, the all time likes or dislikes or likes or dislikes for the most-recent presentation, all comments or comments only provided during the most recent presentation, etc. Note that a detailed current information UI such as the 110 described above may include such estimates and/or past information as well such as when a more information selector element is selected from the UI 150 for an AV content to be aired on a channel in the future.

Now in reference to FIGS. 7-10, an exemplary current information UI is shown but, distinguishing the UIs of FIGS. 7-10 from the previously described UIs, the UI in these figures includes a tabbed format for viewing of various types of current information. In cross-reference to FIGS. 7-10, a UI 168 that may be dynamically updated to include the most recent and/or up-to-date information as possible is shown, and includes a current video portion 170 as well as a current temporal information area 172 that may be e.g. similar to the portion 92 and area 94 described above, respectively. Also shown is a title area 174 indicating in the present exemplary instance what is “happening now.” In addition to the foregoing, the UI 168 includes a detailed current information portion 176 that includes plural tabs that are selectable to cause different types of current information to be presented.

In reference to FIG. 7 in particular, a most views tab 178 is shown as being the operative and/or currently selected tab with current view count information being shown that may be dynamically updated in real time in accordance with present principles. As may be appreciated from FIG. 7, the portion 176 presents indications 180 of plural AV contents that are ranked top to bottom from most CE devices currently viewing the AV content to other AV contents being viewed on less CE devices. As may be appreciated from exemplary FIG. 7, Content One has the most current views and Content Four has the least, with Contents Two and Three having less views than Content One but more than Content Four. Note that at least a portion of each respective indication 180, either or both the content title itself (e.g. “Content One”) or the number of views may be selectable to cause the respective AV content associated therewith to automatically without further user input be presented on the CE device to quickly navigate to e.g. the most popular AV content.

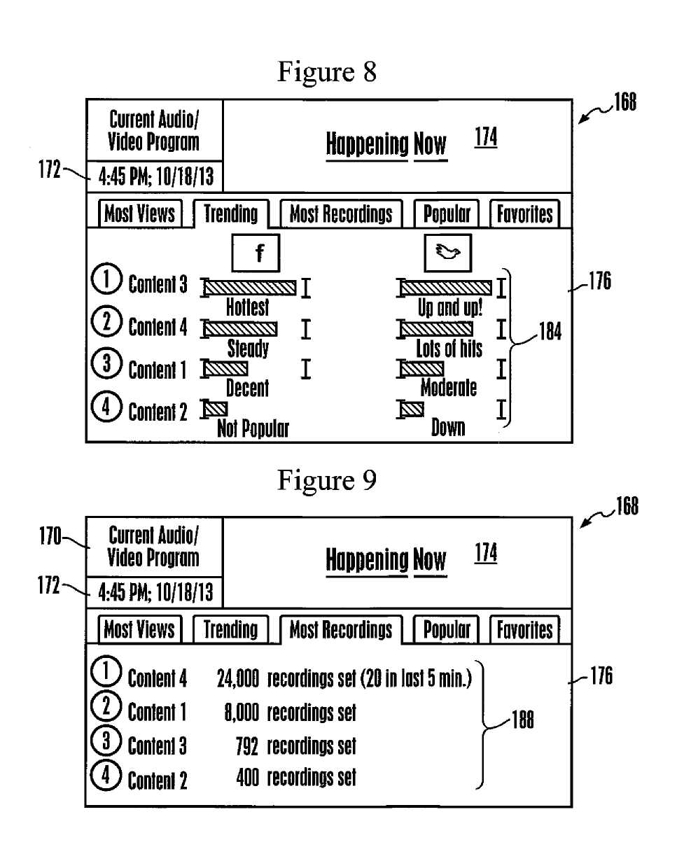

Now in reference to FIG. 8, a trending tab 182 is shown as being the operative and/or currently selected tab with currently trending AV content information being shown that may be dynamically updated in real time in accordance with present principles. As may be appreciated from FIG. 8, the portion 176 now presents indications 184 in the form of bars of various lengths for respective AV contents that are ranked top to bottom from most trending to least trending. Note that each respective indication 184 may be accompanied by and/or include text describing the trend such as “hot” or “trending down.” Also note that there are two columns of indications 184, one for trending according to one social networking service (e.g. Facebook) and one for trending according to another social networking service (e.g. Twitter). In lieu of or in addition to columns for respective social networking services, there may also be a column of cumulative trending totals across all social networking services or user-specified social networking services, though this is not shown for clarity. Nonetheless, as may be appreciated from exemplary FIG. 8, Content Three is trending the most, Content Four is trending but not as much as Content Three, Content One is trending less than Content Four, and Content Two is trending the least of the four. Even further, it is to be understood that at least a portion of each respective indication 184, either or both the content title itself (e.g. “Content One”) or the portion indicating trends may be selectable to cause the respective AV content associated therewith to automatically without further user input be presented on the CE device to quickly navigate to e.g. trending AV content.

Continuing the detailed description in reference to FIG. 9, a most recorded tab 186 is shown (e.g. most anticipated recordings, and/or most anticipated AV content presentations based on data other than recording instances set) as being the operative and/or currently selected tab. The portion 176 as shown in FIG. 9 thus shows recording indications 188 ranked from top to bottom from most recording instances set to least recording instances set, it being understood that the recording instances may be dynamically updated in real time in accordance with present principles. Note that each respective indication 188 may indicate the total number of recording instances that have been set, and also or alternatively the number of recordings set within a (e.g. user-determined) preset amount of time such as within the last twenty minutes. It may be appreciated from exemplary FIG. 9 that Content Four has the most recording instances set, with Content One having the next most instances set, Content Three with the next most instances set, and Column Two with the least instances set of the four contents. Last, note that at least a portion of each respective indication 188, either or both the content title itself (e.g. “Content One”) or the portion indicating recording instances set may be selectable to cause the respective AV content associated therewith to automatically without further user input be presented on the CE device to quickly navigate to e.g. most anticipated AV content.

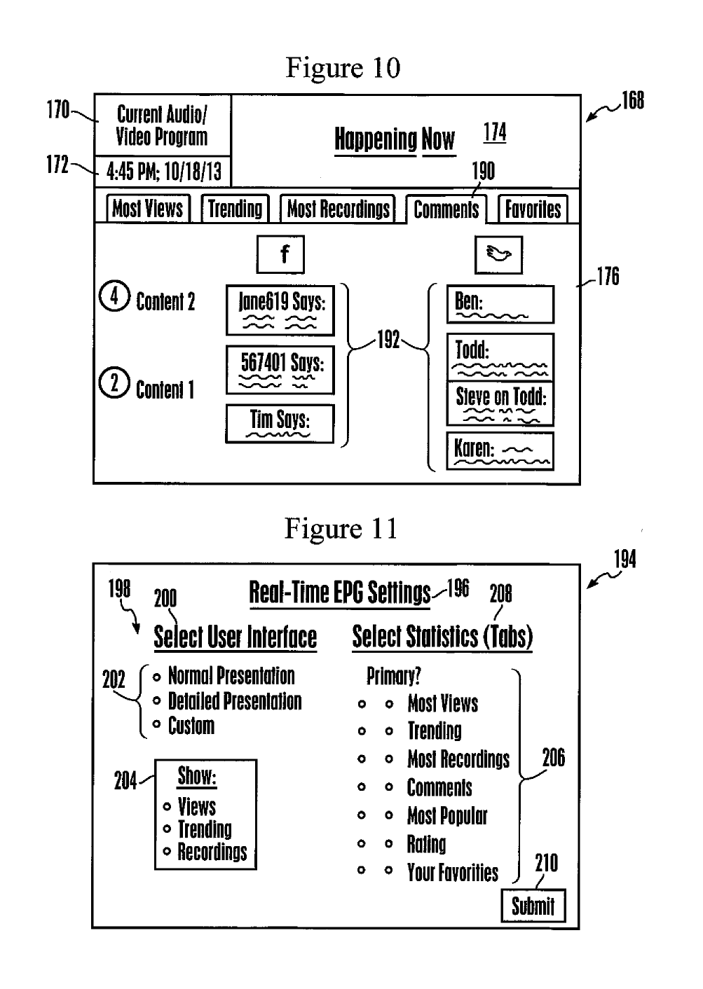

Now in reference to FIG. 10, a comments tab 190 is shown as being the operative and/or currently selected tab with (e.g. social networking) comment information being shown that may be dynamically updated in real time in accordance with present principles. As may be appreciated from FIG. 10, the portion 176 presents comments 192 or at least portions thereof. The AV contents may be presented in non-limiting embodiments on the portion 176 from top to bottom according to e.g. the number of comments for each AV content, with the most commented on AV content appearing at the top (and/or comments specifically by social networking friends of the user and not the public at large appearing at or toward the top). Note that there are two columns of comments such that e.g. Facebook and Twitter comments each pertaining to the same AV content may be separately presented, although if desired in addition to or in lieu of those columns a cumulative comment column may be provided for each AV content regardless of social networking service. For example, the CE device presenting the UI 168 may use artificial intelligence software to determine that comments from different social networking services pertain to the same AV content and present them both together on the UI 168 in a single cumulative column for the subject AV content.

It is to also be understood that in some embodiments, comments appear top to bottom for a single AV content in reverse-chronological order such that the most recent comments are presented at the top, though in other instances such as e.g. based on user-defined settings the comments may instead be presented randomly or in chronological order. In any case, it is to be understood that at least a portion of each respective indication 192, either or both the content title itself (e.g. “Content One”) or the comment areas may be selectable to cause the respective AV content associated therewith to automatically without further user input be presented on the CE device to quickly navigate to e.g. commented-on AV content.

Generally in reference to the examples shown in FIGS. 7-10, it is to be understood that still other tabs may be selectable to cause information associated with the tab to be presented. For instance, a popular tab may be included on the portion 176 of the UI 168 that when it is the operative and/or currently selected tab presents popular AV contents based on data other than that described above (and/or including that described above) such as all-time most popular AV contents based on all user input indications received by an AV content provider and/or popular AV contents as determined by the AV content provider itself. As another example, a favorites tab may be selectable to cause a listing of favorite AV contents and/or favorite channels based on user input provided to the CE device indicating that the contents and/or channels are favorites of the user.

Furthermore, this favorites tab (and indeed any of the tabs and/or UIs/EPGs described herein) may also be dynamic in another aspect in that e.g. favorites that are presented on the portion 176 may change based on the time of day to e.g. indicate user-input favorites that are currently airing at the time of presentation of the UI. Even further, note that information presented responsive to selection to any of the tabs described above may be combined for simultaneous presentation on the portion 176 at any given instance (e.g. based on user-determined settings to combine one or more types of information to be associated with a single tab or presentation) such that e.g. an indication of an AV content with the most views and that is also trending the most may be presented along with an indication of the number of recording instances set for the AV content, and the portion 176 may also include additional indications for other AV contents with e.g. less views, less trending activity, and a different number of recording instances set.

Continuing the detailed description in reference to FIG. 11, an exemplary settings UI 194 for configuring a current information UI (e.g. an EPG) in accordance with present principles is shown. The settings UI 194 includes a title 196 indicating that the settings options shown on the UI 194 pertain to real-time UI settings. Also shown is a first setting section 198 with a title 200 indicating that a UI configuration may be selected, such as e.g. a “normal” presentation such as the one described in reference to FIG. 4, a detailed presentation such as the one described in reference to FIG. 6, or a custom presentation. Each of the options 202 may be selected using a respective radio button associated therewith. Furthermore, note that beneath the custom selection is a sub-options box 204 that may be e.g. grayed-out and not manipulable by a user until such time as the custom selection is selected (e.g. by providing input to the custom selection radio button), at which point the box 204 may no longer by grayed-out and may be manipulable by a user to configure custom settings for an EPG to be presented on the CE device.

The custom settings may thus e.g. be configured directly from the settings UI 194 using the box 204 to include e.g. some but not all detailed current information as described herein. For example, the box 204 may be manipulated to configure the CE device to present a UI including e.g. a current view count for an AV content, whether the AV content is trending, and the current number of recordings set for the AV content, but to not present current information regarding e.g. people's rating of the AV content, the number of likes and/or dislikes the AV content has received, and/or any comments regarding the AV content.

Still in reference to the settings UI 194, it may instead and/or also present a particular statistics option section 206 that includes a title 208 at the top thereof indicating to a user that particular statistics may be selected for presentation on a current information UI in accordance with present principles, and each of the respective options may have two accompanying radio buttons associated therewith. As presented on the exemplary UI 194, the left-most radio button for each option may be selected to configure the CE device to include that particular statistic in a current information UI, while the right-most radio button may be selected after the left-most button for the same option has been selected to configure the CE device to make the option a “primary” statistic (e.g. the right-most button being grayed-out and not being selectable until the left-most button is first selected). The UI 194 also includes a submit button 210 selectable to configure the CE device presenting the UI 194 to present current information UIs in accordance with the options set at the UI 194.

It is to be understood that making a statistic a “primary” statistic may configure the CE device to present the statistic/current information on a current information UI when a user initially requests that the current information UI be presented on a CE device (e.g. responsive to selection of a “guide” button on a remote control), whereas statistics not designated as primary may in some instances only be presented on a UI responsive to selection of e.g. a current information selector element (e.g. such as the element 106 described above) and thus only presented on a “lower-level” UI. In addition to or in lieu of this variance between statistics designated as primary and those not designated as such, it is to be understood that being designated a “primary” statistic may include highlighting, bolding, changing font size and/or color, etc. of a primary statistic to distinguish it from other statistics not designated as primary but nonetheless presented on the same current information UI.

Still in reference to FIG. 11, note that the exemplary UI 194 may include configurable settings to present or not present on a current information UI any of the statistics, metrics, current information, etc. described herein even if not specifically shown in FIG. 11. Also note that the UI 194 may be incorporated into a larger and/or general CE device setting UI, and/or it may form part of a separate settings UI only for configuring a UI for presentation of current and/or real-time information in accordance with present principles.

Thus, based on the foregoing, it may be appreciated that current and/or up-to-date information for one or more AV contents and indeed for (e.g. TV) channels may be presented on a UI on a CE device and dynamically updated constantly and/or substantially in real-time as updates become available and/or as current information data changes. In exemplary embodiments AV content for which current information is presented may be a television program broadcasted by a cable and/or satellite head end. For instance, the number of likes and/or dislikes for a particular AV content may be presented on a current information UI next to other information for the AV content, such as its title. Moreover, in some embodiments the number of likes and dislikes for a particular AV content as presented on a current information UI may be an aggregation of likes and dislikes of the AV content that have been input to different social networking services, where the CE device presenting the current information UI has been configured to have access to the social networking services and may thus receive and/or otherwise acquire data from the social networking services to aggregate likes and dislikes for such purposes. However, in addition to or in lieu of the foregoing, note that the social networking services, servers disclosed herein, and/or head ends disclosed herein themselves may directly provide such like/dislike information without any aggregation being executed at the CE device.

Still in reference to the social networking aspects of present principles, further note that the current information UIs disclosed herein may be configured (e.g. based on a settings UI such as that described in reference to FIG. 11 or a “Friends” tab in accordance with present principles) to present current information for one or more AV contents based only on data derived from social networking friends of a user associated with the CE device (e.g. data derived from social networking friends from only one social networking service or more than one). Thus, a user may be able to view current information for a particular AV content not based on the public at large, but instead based on e.g. what is trending according to the user's social networking friends, what has been commented on by the user's social networking friends, what has been liked or disliked by the user's social networking friends, a view count only including a user's social networking friends, a number of anticipated recordings including only those instances set by a user's social networking friends, ratings determined only based on input from a user's social networking friends, etc.

Notwithstanding social networking aspects in accordance with present principles, note that if desired a current information UI as described herein may present comments input directly at other instances of a current information UI presented on other CE devices e.g. by other users such that comments can be made and viewed on the UI outside the context of a social networking service specifically. Likes and dislikes may be similarly indicated.

Regardless, it is to be further understood that while presenting a current information UI on a CE device and responsive to receiving user input to change presentation of AV content on the CE device from one AV content to a different AV content, the CE device may provide and/or transmit to a server a notification indicating the change in presentation. This notification may be utilized by the server to (e.g. constantly and/or periodically at regular intervals) provide information updates to CE devices in communication therewith, including a view count for the AV content that has been changed to which includes a view number accounting for the presentation of the changed-to AV content on the CE device (e.g. tuning in to an AV content on a CE device may cause a notification to be sent to the server to increase the total view count for that AV content by one to account for the AV content being viewed on the CE device). Likewise, the notification may include (and/or a separate notification may be sent) data indicating to the server that the tuned-away from AV content has ceased being presented on the CE device so that the view count for the tuned-away from AV content can be decreased by one to account for one less CE device presenting the AV content.

Concluding the detailed description, note that although AV content specifically has been discussed throughout, present principles may similarly apply to video-only content, as well as audio-only content such as e.g. content provided via a music channel of a TV service.

While the particular ELECTRONIC PROGRAMMING GUIDE WITH REAL-TIME AUDIO VIDEO CONTENT INFORMATION UPDATES is herein shown and described in detail, it is to be understood that the subject matter which is encompassed by the present invention is limited only by the claims.

1. An audio video device (AVD), comprising:
a processor configured for controlling a display;
at least one computer readable storage medium that is not a carrier wave and that is accessible to the processor, the computer readable storage medium bearing instructions which when executed by the processor cause the processor to:
present, on the display, at least an user interface (UI) of available audio video (AV) content (programming), the UI including current information for at least one available AV content including a first AV content, current information for the first AV content including the current number of other AVDs presenting the first AV content, the current rating of the first AV content, the current number of likes or dislikes of the first AV content, the current number of comments regarding the first AV content, and an indication of whether the first AV content is currently trending.

2. The AVD of claim 1, wherein the first AV content is a television broadcast.

3. The AVD of claim 1, wherein the current information regarding the current number of other AVDs presenting the first AV content is updated on the UI substantially in real time as the UI is presented.

4. The AVD of claim 1, wherein the current information regarding the current rating of the first AV content is updated on the UI substantially in real time as the UI is presented.

5. The AVD of claim 1, wherein the current information regarding the current number of likes or dislikes of the first AV content is updated on the UI substantially in real time as the UI is presented.

6. The AVD of claim 5, wherein the likes and dislikes are associated with input to a social networking service to which the processor is configured to have access.

7. The AVD of claim 5, wherein the number of likes and dislikes is an aggregation of likes and dislikes of the first AV content based on input to plural social networking services, the number of likes and dislikes being accessible to the processor.

8. The AVD of claim 1, wherein the current information regarding the current number of comments concerning the first AV content is updated on the UI substantially in real time as the UI is presented.

9. The AVD of claim 1, wherein the indication of whether the first AV content is currently trending is updated on the UI substantially in real time as the UI is presented.

10. The AVD of claim 1, wherein the UI is an electronic programming guide (EPG) and the current information is information that is updated on the UI substantially in real time as changes to the information are received from a server providing the current information.

11. The AVD of claim 1, wherein the current information included on the UI is received from an Internet server at least in part using a hypertext transfer protocol (HTTP) application programming interface (API).

12. A method, comprising:
presenting, on a display, a user interface (UI) including information for each of plural audio video (AV) contents, the information being indicated on the UI; and
updating the information on the UI as the UI is presented, the updating being substantially in real time as at least one information update for at least one portion of the information for at least one AV content is received;
wherein information for a first AV content includes a view count of the number of current presentations of the AV content on separate consumer electronics (CE) devices, the view count being updated on the UI substantially in real time as an information update for the view count is received.

13. The method of claim 12, further comprising presenting the first AV content on at least a portion of the display, and responsive to receiving user input to change presentation of AV content on at least a portion of the display from the first AV content to a second AV content, providing to a server a notification indicating the change in presentation from the first AV content to the second AV content, the notification being utilizable by the server for the server to provide information updates including a view count for the second AV content that includes a view number accounting for the presentation of the second AV content on the display.

14. The method of claim 13, further comprising responsive to receiving user input to change the presentation of AV content on at least a portion of the display from the first AV content to the second AV content, ceasing to present the first AV content on any portion of the display and presenting the second AV content on at least a portion of the display.

15. The method of claim 13, wherein the notification includes information indicating that the first AV content is no longer being presented on the display, the notification being utilizable by the server to provide information updates including a view count for the first AV content that includes a view number that does not include a presentation of the first AV content on the display.

16. The method of claim 13, wherein the user input to change presentation of AV content on at least a portion of the display from the first AV content to the second AV content is received at least in part based on manipulation of the UI.

17. A computer readable storage medium that is not a carrier wave, the computer readable storage medium bearing instructions which when executed by a processor of a consumer electronics (CE) device configure the processor to execute logic comprising:
presenting, on a display device controllable by the processor, at least an user interface (UI) of available audio video (AV) content, the UI presenting information for at least one AV content including a first AV content, information for the first AV content including the current number of individual consumer electronics (CE) device recording instances that have been set at respective CE devices to record the first AV content on the respective CE devices.

18. The computer readable storage medium of claim 17, wherein the UI presents information for the first AV content including the current number of other CE devices presenting the first AV content, the current rating of the first AV content, and the current number of comments regarding the first AV content.

19. The computer readable storage medium of claim 17, wherein the information is presented responsive to selection of an anticipated recordings selector element on the UI.

20. The computer readable storage medium of claim 19, wherein responsive to selection of the anticipated recordings selector element, information is presented for plural AV contents including the current number of individual consumer electronics (CE) device recording instances that have been set at respective CE devices to record each of the plural respective AV contents on the respective CE devices.
